(19) United States
(12) Patent Application Publication
(10) Pub. No.: US 2002/0196941 A1
(43) Pub. Date: Dec. 26, 2002

(54) Method and system for providing secure digital sound recording

(76) Inventors: Shawn Ray Isaacson, Roy, UT (US); Richard Tolan Brown, Roy, UT (US); Ronald Frank Hales, Riverdale, UT (US)

Correspondence Address: Thomas E. Watson, WOODCOCK WASHBURN KURTZ, MACKIEWICZ & NORRIS LLP, One Liberty Place - 46th Floor, Philadelphia, PA, 19103, US

(21) Appl. No.: 09/888,001

(22) Filed: Jun. 21, 2001

(51) Int. Cl. H04N 7/167

(52) U.S. Cl. 380/231; 705/54; 380/201; 705/57

(57) ABSTRACT

A method and system are provided wherein captured digital data from an application rendering digital data on a client computing device or downloaded thereto is converted into a secure (encrypted) digital format. Then, certain digital rights are applied to the digital data, such as the right to play and listen to the file x number of times, for a set period of time, unlimited play rights on that computer, the right to transfer to a portable device, or other like license limitations. This technique can build on existing architectures such as a system using the Total Recorder product. Thus, in connection with storage of captured digital data, the present invention converts the file into a secure format and applies DRM rules to the file depending upon the nature of the content and/or default rules for downloading or recording content. One may purchase additional rights to the digital data as well.

### CROSS-REFERENCE TO RELATED APPLICATION

This patent application is related to U.S. patent application Ser. No. XX/yyy,zzz, filed MM/DD/YYYY. [Attorney Docket No. IOME-0391]

### FIELD OF THE INVENTION

The present invention relates generally to a method, device and system for providing secure digital sound recording.

### BACKGROUND OF THE INVENTION

The Internet now provides a vast array of streaming media content for listening and/or viewing while online. However, currently there is no practical way of capturing or recording the audio and/or video portion of the streaming media in a copy-protected manner so that a user can listen to or view the presentation at a later time, but also so that the user cannot freely copy and distribute the recorded material. This problem has existed in connection with other media rendering and recording devices e.g., VCRs for television content, or tape recorders for audio signals, but with at least one key difference. Since streaming media content can be recorded with virtually no signal loss, this poses a “risk” for copyright owners that their works will be freely shared (pirated) without compensation. With VCRs and tape recorders, the device(s) and transmission media invite noise or corruption of data into the recording process. With streaming media, there is no reason why virtually lossless analog to digital conversion cannot be effected, at least to the limits of human ear capabilities, and there is no reason why unadulterated digital data cannot be stored and freely distributed. Thus, it would be desirable to prevent unfettered re-distribution of digital data because there is little difference between what copyright owners can provide for a fee and what one's friends, randomly located servers or even anonymous client devices, e.g., in the case of peer to peer networks like Napster and Gnutella, can provide for free. Thus, with respect to streaming content, there is currently no practical way for the recorded data to be stored “securely” on a user's computer and also locked to that computer with certain rights applied, otherwise known as Digital Rights Management (DRM).

Thus, it would be advantageous to provide rights that enable the ability to transfer recorded audio to a portable device, or unlimited playback on the user's computer. It would be advantageous to the copyright owners because the user would not have the right to email, copy, or re-distribute the recorded media unless the copyright owner allowed them to do so. It would be advantageous to the user because the user may still easily choose and receive high quality copyrighted content on impulse. This would then fall under the umbrella of the Audio Home Recording Act (AHRA) of 1992, in which Congress legislated that a person may record media content in their own homes (specifically music, TV, and movies) for their own home private use. The AHRA states that digital recording devices must contain a serial copy management system. The problem with the AHRA is that computers are exempted from the act. So the act states that people who use AHRA approved devices to copy music are immune from prosecution. It is thus not clear whether people who use non-AHRA approved devices, e.g. a computer, are immune from prosecution. Thus, it would be beneficial to all to meet the requirements of the AHRC so that any digital recording device utilized in connection with computing devices has a serial copy management protection mechanism in place.

High Criteria is a company that has a universal sound recording product called Total Recorder that can capture audio streams, or any audio played on one's computer, and save it to an unsecured wave file that can be re-distributed. Total Recorder can capture live audio, line-in sound, CD playback, etc. and can convert different sound formats to WAVE and MP3. Other similar products can be found such as AudioJacker. There is thus a tremendous interest in music and the Internet as a place to find, listen, download, and enjoy music and entertainment. As a result, record companies are pursuing companies that help to enable the downloading and re-distribution of music. Many companies are turning from a download business/process to a streaming business/process and are using advertising, as a way to generate revenue while they stream the data to users. When data is streamed to the users, the intent is to allow the user to view or hear the content without allowing the user to capture or record the event. This is similar to the way broadcast television worked before the advent of the VCR, and to the way radio broadcasting worked before the advent of tape recorders.

Since the AHRA essentially states that users can record such television events, radio events, etc. for their own personal home use, it is a defensible position that the Internet should be no different in terms of being able to record an event for home private non-commercial use.

FIGS. 1A through 1C illustrate exemplary operation of the Total Recorder product variously configured in a computing device. Total Recorder records analog sound digitized by a sound card, as well as sound generated, or requested, by other computer programs, such as RealPlayer, Windows Media Player, Quick Time, WinAmp, and many others. Recorded sound is saved in wave-file format. For example, one can use Total Recorder to record audio from the Internet, either audio files or live streams, music from a game program, a conversation produced from an Internet telephony program and/or the like. Thus, some application 100 produces or reproduces sound from whatever source. Total Recorder uses a virtual sound driver 110 to capture the sound output from another program 100. By installing this driver 110, and setting this device as the default, different sound reproducing programs 100 send their output stream to Total Recorder's driver 110 and not to the driver of a real device e.g., sound card driver 120. The Total Recorder product then passes the information to the sound card driver 120, which in turn forwards the audio to sound card 130. Thus, the total recorder driver behaves similarly to the sound board driver from the perspective of a sound source 100, and thus basically intercepts sound in transit to the sound board driver 120.

As illustrated in FIG. 1B, the Total Recorder product enables a user to capture and record sound played back or requested by other computer programs 100a. As a middleman between the sound program 100a and the sound card driver 120 (and subsequent sound card 130 and speakers 140), the total recorder driver 110 can split its output, so that Total Recorder product 150 can intercept and store the sound in storage 20.

As illustrated in FIG. 1C, Total Recorder also enables users to record sound output from a source 100b digitized by a sound card 130. Source 100b includes a microphone, CD or other input lines. In this case, Total Recorder product 150 receives an output from sound board driver 120, and Total Recorder product 150 stores the content in storage 20.

In each case, Total Recorder product 150 enables a user to store an unrestricted unadulterated digital copy of content in his or her hard drive or other storage 20, which in turn enables unrestricted re-distribution of quality content, the concept anathema to copyright owners.

There are also other digital recording products presently on the market, such as Photoshow recording product, but none presently invoke digital rights management functions to satisfy the AHRA.

Accordingly, it would be of mutual benefit to users and copyright owners to find a system which compromises between (1) the needs of users to download content on demand and own the content for their personal enjoyment and (2) the needs of copyright owners to produce revenue from copyright ownership, while preventing unrestricted redistribution. It would be further beneficial to provide a solution that works in the face of applications like Total Recorder that can spoof an otherwise secure and workable process. It would be further advantageous to provide a digital recording device that satisfies the requirements of AHRA. Thus, it would be advantageous to provide a computing device for capturing (recording) the audio and/or video portion of the streaming media (source can be analog or digital in nature) in a copy protected manner so a user can listen to or view the presentation at a later time but the user cannot freely copy and distribute the recorded material.

### SUMMARY OF THE INVENTION

The present invention provides a computing device that converts captured digital data from an application rendering digital data on a client computing device or downloaded thereto into a secure (encrypted) digital format. Then, certain digital rights are applied to the digital data, such as the right to play and listen to the file x number of times, for a set period of time, unlimited play rights on that computer, the right to transfer to a portable device, or other like license limitations. The present invention can build on existing architectures such as a system using the Total Recorder product. Thus, in connection with storage of captured digital data, the present invention converts the file into a secure format and applies DRM rules to the file depending upon the nature of the content and/or default rules for downloading or recording content. One may purchase additional rights to the digital data as well.

Other features of the present invention are described below.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The method and system for providing secure digital sound recording are further described with reference to the accompanying drawings in which:

FIGS. 1A through 1C represent exemplary prior art systems that facilitate unrestricted recording and redistribution of content in computer systems, in view of which the present invention provides a secure solution.

FIG. 2 represents an exemplary network environment in which the present invention may be implemented.

FIG. 3 is an exemplary embodiment of the present invention in which DRM rights are applied to downloaded content before being stored in a computer system, in accordance with the present invention.

FIG. 4 is a flow chart illustrating an exemplary technique as a result of which DRM rights are applied to content in accordance with the present invention.

FIGS. 5 and 6 are photographic representations of an exemplary computing device for recording and playing back content, and applying and interpreting DRM rights in accordance with the present invention.

FIG. 7 is a flow chart illustrating an exemplary process whereby content is bound to a storage medium playable on a computing device in accordance with the present invention.

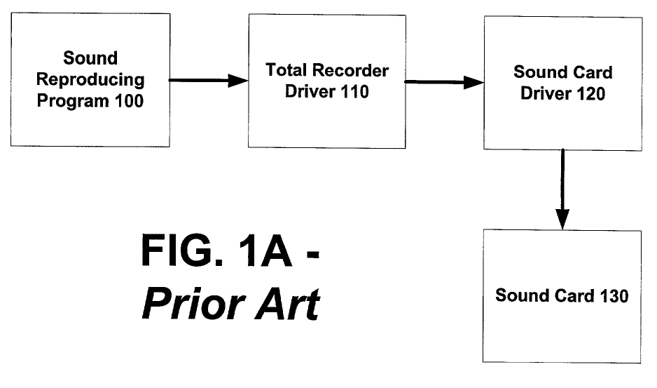

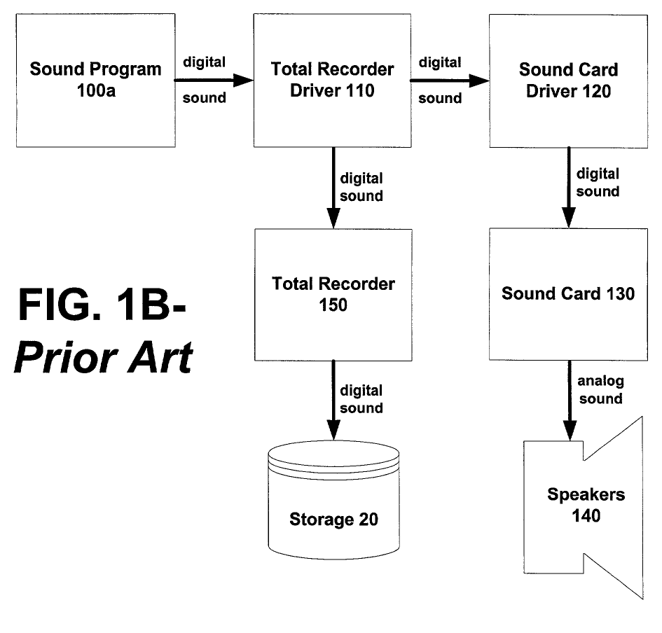

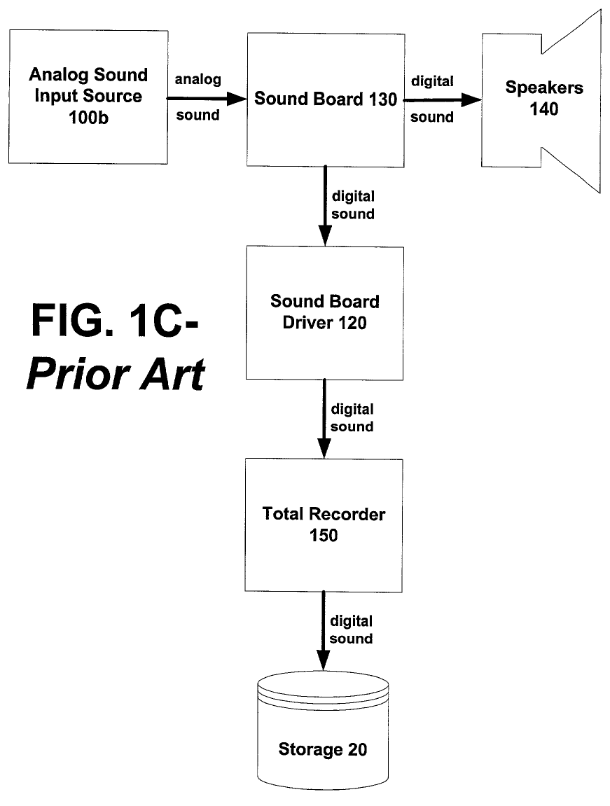

### DETAILED DESCRIPTION OF THE INVENTION

Overview

The present invention is directed to a computing device for recording the audio and/or video portion of streaming media in a copy protected manner so that a user can listen to or view the presentation at a later time while being prevented from freely copying and/or distributing the recorded content. The invention provides a way for the recorded data to be stored securely on a user's computing device and ‘locked’ to that computing device with certain DRM rights applied to the data. These rights may comprise, for instance, the ability to transfer recorded audio to a specific portable device, or allow unlimited playback, but only on the user's computer. The user would not have, however, the right to email, copy, or re-distribute the recorded media from the computing device unless the copyright owner allowed them to do so. The invention thus provides a system that would fall under the umbrella of the AHRA in which Congress legislated that a person can record various media in their own homes for their own home private use. Thus, the present invention provides a computing device consistent with having a serial copy management system to immunize users from prosecution for recording various content downloaded from the Internet or otherwise produced or reproduced on the computer. In one embodiment, a computing device tailored for these purposes is referred to as a “ZipDeck.”

The present invention can apply to any other computing device that also records sound and/or video, such as a Photoshow device that records sound and video, or any future digital recording product as well, since the application of DRM rights is ultimately determined by the computing device and software/firmware therein in accordance with the present invention. For example, the computing device of the present invention enables a user to record an Internet broadcast TV show with digital rights management for free. Later, the user could potentially pay a fee for the right to then burn the show onto a CD-RW, CD-R, DVD-R, DVD-RAM, etc. as a movie file to be played on a home DVD Player system. The beauty of DVD is that the content can be encrypted (with Digital Rights Management function, or it can be un-encrypted content with no rights assigned.) The system and method for paying for content for additional rights could include a pay structure to record encrypted (DRM protected) DVD content, or for an additional fee the right to record unsecured DVD content.

Exemplary Computing and Network Environments

A computer 110 or other client device can be deployed as part of a computer network. Thus, the present invention pertains to any computer system having any number of memory or storage units, and any number of applications and processes occurring across any number of storage units or volumes. The present invention may apply to an environment with server computers and client computers deployed in a network environment, having remote or local storage.

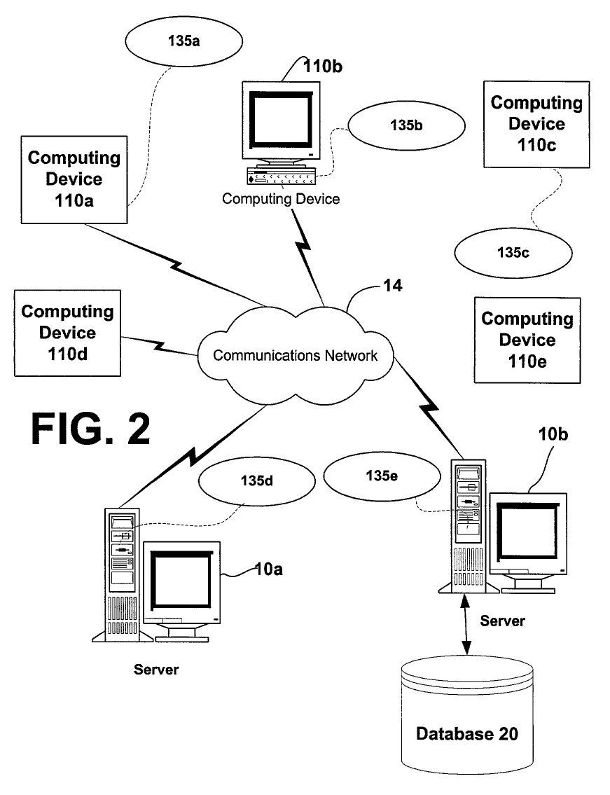

FIG. 2 illustrates an exemplary network environment, with a server in communication with client computers via a network, in which the present invention may be employed. As shown, a number of servers 110a, 110b, etc., are interconnected via a communications network 14 (which may be a LAN, WAN, intranet or the Internet) with a number of client or remote computing devices 110a, 110b, 110c, 110d, 110e, etc., such as a portable computer, handheld computer, thin client, networked appliance, or other devices, such as a VCR, TV and the like in accordance with the present invention. In a network environment in which the communications network 14 is the Internet, for example, the servers 10 can be Web servers with which the clients 110a, 110b, 110c, 110d, 110e, etc. communicate via any of a number of known protocols such as hypertext transfer protocol (HTTP). Communications may be wired or wireless, where appropriate. Client devices 110 may or may not communicate via communications network 14, and may have independent communications associated therewith. For example, in the case of a TV or VCR, there may or may not be a networked aspect to the control thereof. Each client computer 110 and server computer 10 may be equipped with various application program modules 135, and with connections or access to various types of storage elements or objects, across which files, video and/or audio may be stored or to which portion(s) of files may be downloaded or migrated. Any server 10a, 10b, etc. may be responsible for the maintenance and updating of a database 20 in accordance with the present invention, such as a database 20 for storing content. Thus, the software of the present invention can be utilized in a computer network environment having client computers 110a, 110b, etc. for accessing and interacting with a computer network 14 and server computers 10a, 10b, etc. for interacting with client computers 110a, 110b, etc. and other devices 111 and databases 20. Thus, when the software of the invention is brought into such an exemplary environment, the computer(s) on which it is stored may communicate with various client computers 110 and devices 111 via the communications network 14, or other wired and/or wireless means.

Providing Secure Digital Sound Recording

The present invention generally provides a system and method to record audio produced on a computer played from a client machine and to record that content with enforceable DRM rights. The present invention also enables a user to record audio produced on a client computer from a network (LAN, WAN, Home Network, Internet, etc.) and to record that content with enforceable DRM rights. The present invention further enables a user to record video and/or audio played from a client computer and to record the video with enforceable DRM rights. The present invention further enables a user to record video and/or audio played from a network (LAN, WAN, Home Network, Internet, etc.) and record that content with enforceable DRM rights. The present invention still further provides a method and system for compensating content and copyright owners that would enable additional rights to be applied to content that was previously securely recorded.

For example, the present invention enables a user to record an Internet broadcast TV show with digital rights management for free. Later, the user potentially pays a fee for the right to then burn the show onto a CD-RW, CD-R, DVD-R, DVD-RAM, etc. as a movie file to be played on a home DVD Player system. A nice quality of DVDs is that the content can be encrypted (with Digital Rights Management function, or it can be un-encrypted content with no rights assigned.) The system and method for paying for content for additional rights may include a pay structure to record encrypted (DRM protected) DVD content, or for an additional fee the right to record unsecured DVD content.

This invention overcomes disadvantages in the prior art by converting the captured wave file into a secure (encrypted) digital format then applies certain digital rights to the file (i.e. the right to play and listen to the file x number of times, or for a set period of time, or unlimited play rights on that computer, or the right to transfer to a portable device.

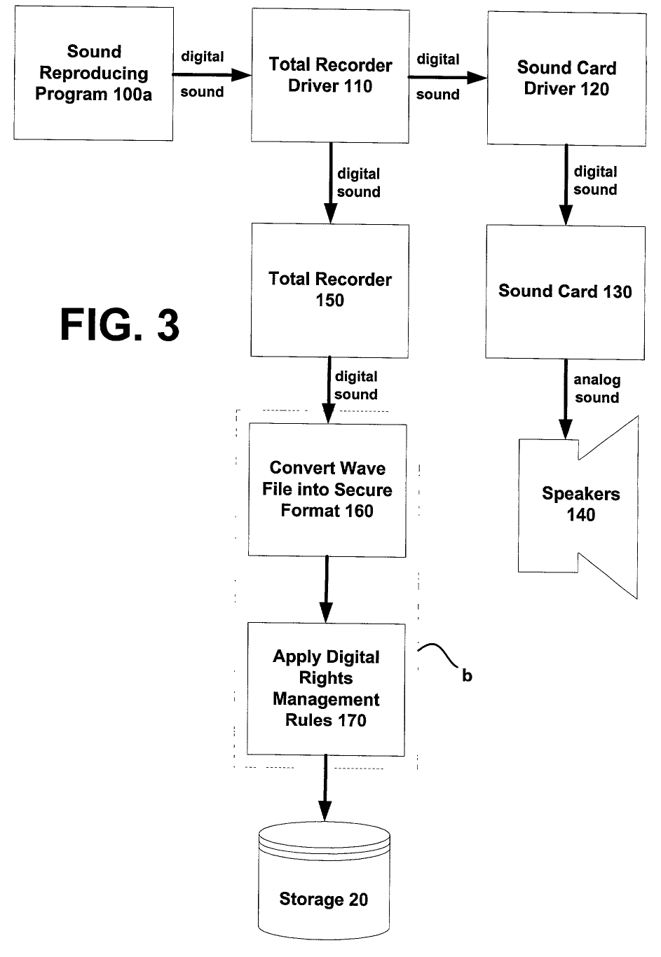

As illustrated in FIG. 3, the present invention can build on existing architectures such as a system using the Total Recorder product described in the background section, although other systems are contemplated herein as well. Thus, before Total Recorder or other like application 150 records the content to storage 20, the present invention converts the file into a secure format with object 160. At 170, the present invention applies DRM rules to the file, depending upon the nature of the content, and/or default rules for downloading or recording content.

Features of the present invention are highlighted in the dashed box b, as distinguished from the previous art. The secure format provided at 160 could be a recognized secure format (i.e. Secure Windows Media format—wma, Intertrust, etc.) The process for converting the wave into a secure format can be accomplished with Microsoft's Media Encoder SDK kit along with the rights application. Applying these two programs together thus gives the user a legal recording studio with a serial copy management system that would satisfy the Audio Home Recording Act of 1992 provisions.

One could potentially buy additional rights to a file in accordance with the present invention. When the user records the file, the file has the original set of “free” rights, or rights for which there is no fee (such as rights to play the content on that computer only). If the user then also wants the right to bum that file onto a CD, the contents of the file could be evaluated as to the copyright owner and compensation rendered for the right to bum that file on a CD for a set or negotiated price.

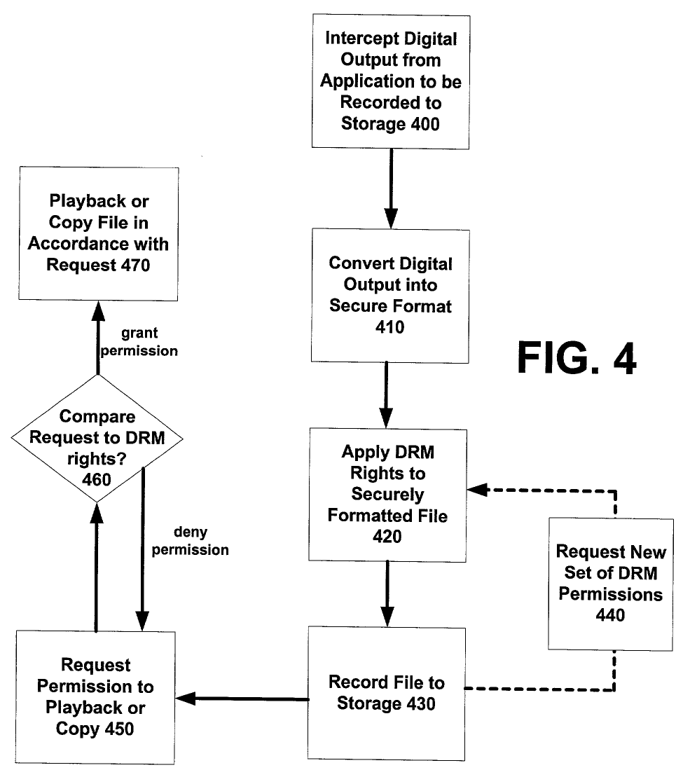

FIG. 4 illustrates an exemplary technique in accordance with the present invention. At 400, the digital output from an application, such as the above-described Total Recorder product or driver, is received by the software of the present invention. At 410, the digital content is converted into a secure format. At 420, DRM rights are applied to the content. At 430, the file is recorded into storage. Optionally, at 440, the user may request a new set of permissions for the file, which may implicate a fee, or other change in license terms.

Once the file is stored with a certain set of permissions, at 450, the user may request permission to perform some action on the content, such as playback, alter or copy the content. At 460, it is evaluated whether the request can be granted vis-a-vis the DRM rights represented in the file. If the request falls within the permission set represented by the DRM rights, at 470 the request is fulfilled, and the action requested is performed. If the request does no fall within the permission set represented by the DRM rights, the request is denied and the user may make another request at 450, or attempt to request a new set of DRM permissions at 440.

For example, one could record an Internet broadcast TV show with digital rights management for free. Later, the user could potentially pay a fee for the right to then burn the show onto a CD-RW, CD-R, DVD-R, DVD-RAM, etc. either as a movie file to be played on a home DVD Player system. An advantage of DVD is that the content can be encrypted (with Digital Rights Management function, or it can be un-encrypted content with no rights assigned.) The system and method for paying for content for additional rights could also include a pay structure to record encrypted (DRM protected) DVD content, or for an additional fee the right to record unsecured DVD content.

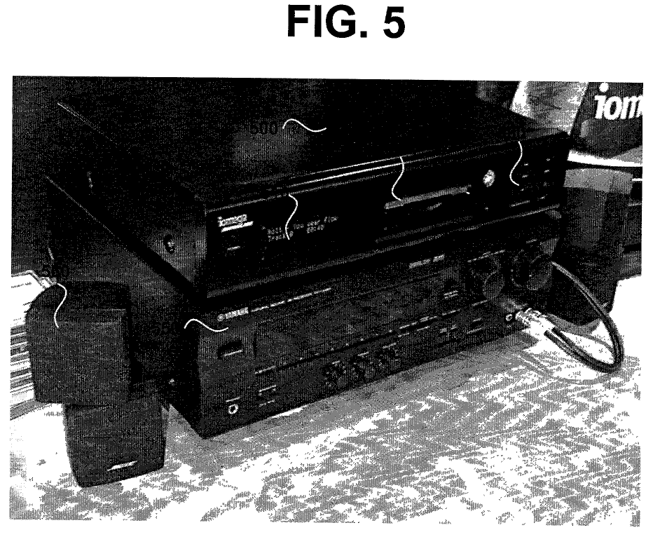

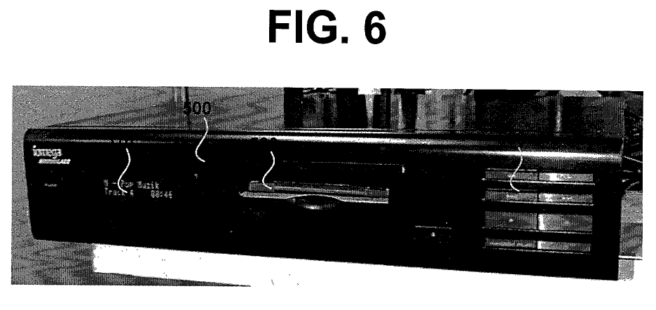

FIGS. 5 and 6 illustrate an exemplary computing device, e.g. a ZipDeck, which can play a digital media file, as well as digitally record an analog sound source. FIG. 5 shows the ZipDeck 500 connected to an analog Receiver/Amplifier 550 and speakers 560. In this configuration the secure digital media files can be played from the ZipDeck 500 and the sound can be delivered to the amplifier 550 for listening. By plugging the output lines from the amplifier 550 into the input jacks on the ZipDeck 500, one can then digitally record an analog signal, encrypt the file and have certain Digital Rights applied to the recorded file. ZipDeck 500 may have display 510, a user interface 530 operable by remote control and a storage medium 520, which may be a hard drive or removable storage medium. FIG. 6 illustrates a closer view of the ZipDeck 500, with a familiar display unit 510, and control buttons 530 (i.e. play, pause, stop, fast forward and rewind, next and previous track, a Record button, and the like.) ZipDeck 500, and other computing devices in accordance with the present invention, may include any of analog video and audio output jacks, a headphone jack, analog audio input jacks, digital audio input jacks, an analog video input jack and a digital video input jack which could be in the form of a DV capture IEEE 1394 Firewire Jack or USB to capture a Digital Video signal, and a network jack to connect and capture network broadcast video and sound.

The configuration pictured shows an Iomega Zip® drive and storage medium 520 as the recording and playback medium, respectively. However, it will be appreciated by one of ordinary skill in the art that this invention can be accomplished with a CD-R/RW drive, Jaz Drive, Floptical drive, MO Drive, PocketZip Drive, Hard Drive, or connected to a network for its storage and playback needs. Thus, all of these configurations may work with this invention.

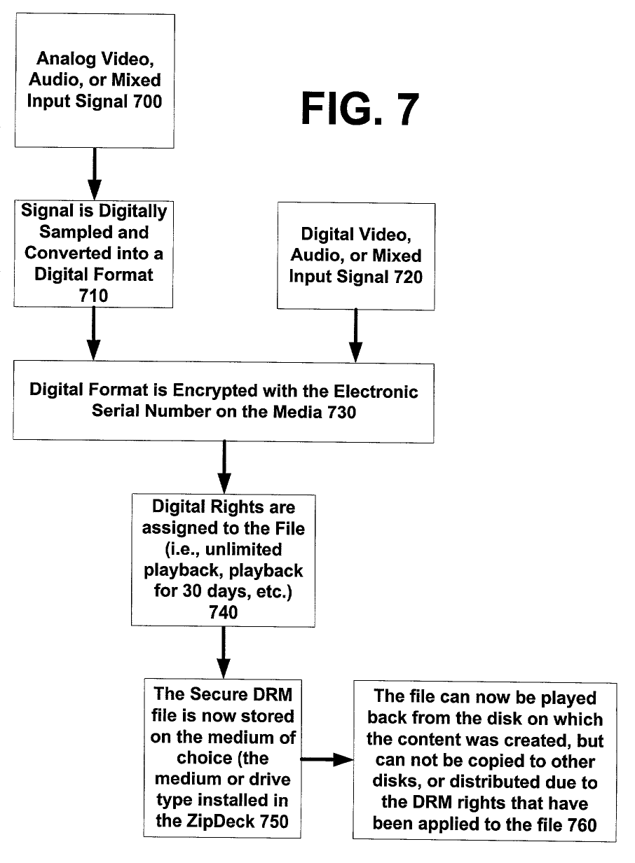

FIG. 7 is a flow chart relating to recording and protecting content, applying digital rights and storing the file for playback in accordance with serial copy management control. At 700, an analog signal is connected to the computing device of the present invention. At 710, the analog signal is digitally sampled and converted into a digital format. At 730, the digitally formatted signal is encrypted with the serial number on the medium 520. For media types that do not have a media serial number, ZipDeck 500 may assign a random number that is encrypted and hidden from the user, in order to simulate a serial number of the medium 520. Alternatively, the incoming content may already be digitally formatted at 720. At 740, digital rights are assigned to the file i.e., unlimited playback, playback for 30 days, etc. At 750, the secure DRM file is stored on the medium of choice, such as the medium 520 or a drive type installed in the ZipDeck 500. At 760, the file may be played back from the disk on which the file was created, but the file may not be copied to other disks, or otherwise re-distributed in violation of the DRM rights.

In order to purchase or otherwise gain additional rights to the file, a ZipDeck network jack may be connected to a LAN/WAN, telephone line or the like that is connected to the Internet. The user can choose to “unlock” or buy additional rights to the file by following the prompts on the display screen. In an exemplary embodiment, the connection to the Internet may be used to connect the user to a service (provided an account has been previously setup online) where the user could choose to pay for additional rights by selecting the appropriate options. The ZipDeck would send the request from the user to pay for additional rights to the account on the Internet along with the Recording Content ID number and content sample. After the Web site confirmed the request for rights, and authenticated the file, the Web site could then send a license file back to the ZipDeck authorizing additional rights. These rights could be utilized to unlock the file and remove the DRM rights altogether or to allow a digital output to a CD burner, or to allow the file to be emailed or distributed to a particular user. There are an unlimited number of possibilities for rights to be utilized, and this invention provides a method of communication and rights management update functions to the hardware player, or other computing device itself.

The described method can be implemented using a variety of different technical architectures including both server and client side execution. It may be implemented in code or generated from meta descriptions. The preceding exemplifies merely some of the possible implementation technologies.

The various techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, DVD-ROMs, ROMs, PROMs, EPROMS, EEPROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention. For example, the storage techniques used in connection with the present invention may invariably be a combination of hardware and software.

While the present invention has been described in connection with the preferred embodiments of the various Figures, it is to be understood that other similar embodiments may be used or modifications and additions may be made to the described embodiment for performing the same function of the present invention without deviating therefrom.

Furthermore, it should be emphasized that a variety of computer platforms, including handheld device operating systems and other application specific operating systems are contemplated, especially as the number of wireless networked devices continues to proliferate. Therefore, the present invention should not be limited to any single embodiment, but rather construed in breadth and scope in accordance with the appended claims.

What is claimed is:

1. A computing device comprising storage and a processor, wherein said processor records into said storage digital data received from one of an analog and digital source, and said processor applies DRM rights to said digital data and said processor enforces the DRM rights whereby the digital data may be played back only from said storage according to said DRM rights.

2. A computing device according to claim 1, wherein said storage comprises one of a magnetic, optical, and magneto-optical medium.

3. A computing device according to claim 1, wherein said storage includes a removable storage medium, and said digital data may be played back only from said removable storage medium.

4. A computing device according to claim 1, wherein said storage includes a hard drive, and said digital data may be played back only from said hard drive.

5. A computing device according to claim 1, wherein the digital data includes data representing audio.

6. A computing device according to claim 1, wherein the digital data includes data representing video.

7. A computing device according to claim 1, wherein the one of an analog and digital source is an analog source signal that is converted to a digital format.

8. A computing device according to claim 1, wherein said processor converts the digital data to a secure format, assigns a default set of DRM rights to the securely formatted data and stores the digital data after such converting and assigning.

9. A computing device according to claim 1, wherein said processor receives a request for a new set of DRM rights, different from an initially applied set of DRM rights and alters the set of DRM rights in accordance with the requesting if at least one condition is met.

10. A computing device according to claim 9, wherein said at least one condition includes one of a promise to pay and a payment for the new set of DRM rights requested.

11. A computing device according to claim 8, wherein the assigning includes assigning a default set of rights dependent upon the type of content that the digital data represents.

12. A computing device according to claim 1, wherein said processor converts said digital data from a Wave (.wav) file to said secure format.

13. A computing device according to claim 1, wherein a user requests via a user interface an action to be performed on said stored digital data and said processor compares said requested action against the set of DRM rights assigned to the digital data.

14. A computing device according to claim 13, wherein said processor denies said request if said requested action is not allowed according to set of DRM rights.

15. A computing device according to claim 13, wherein said processor grants said request if said requested action is allowed according to set of DRM rights.

16. A computing device according to claim 1, wherein said digital data is downloaded computing device from a network.

17. A computing device according to claim 16, wherein said digital data is downloaded to the computing device from at least one of a wired and wireless network transmission means.

18. A computing device according to claim 16, wherein said digital data is downloaded to the computing device from at least one of a LAN, WAN, Home Network and the Internet.

19. A server computing device for receiving requests for DRM rights via a network, whereby a user requests an alteration of DRM rights associated with digital data in storage of a computing device as recited in claim 1 in exchange for an obligation from the user, and said server computing device sends data representative of the requested DRM rights to the computing device.
